(19) United States
(12) Patent Application Publication
(10) Pub. No.: US 2006/0260086 A1
(43) Pub. Date: Nov. 23, 2006

(54) Paint tray and roller

(76) Inventor: Michael Boehm, Martins Ferry, OH (US)

Correspondence Address: PEARNE & GORDON LLP, 1801 EAST 9TH STREET, SUITE 1200, CLEVELAND, OH, 44114-3108, US

(21) Appl. No.: 11/134,161

(22) Filed: May 20, 2005

(51) Int. Cl. B05C 21/00

(52) U.S. Cl. 15/257.06

(57) ABSTRACT

A paint tray and a paint roller are provided in which at least one of the paint tray and the paint roller are substantially coated with a non-stick coating. For instance, the non-stick coating can be a polytetrafluoroethylene coating to facilitate easier cleaning of the paint tray and/or paint roller. Alternatively or additionally, the paint tray can include a gasket provided continuously around a bottom portion thereof such that the gasket mitigates slippage of the paint tray on a support surface.

### BACKGROUND OF THE INVENTION

1) Field of the Invention

The present invention relates generally to painting supplies, and more particularly, to a tray for holding a liquid, such as paint, stain, and the like, and a roller for applying the liquid to a surface.

2) Description of the Prior Art

Today, many different types of paint trays exist for holding paint to be applied to surfaces such as walls and ceilings. The most common paint tray, as commonly known in the art, is constructed having a ramped front surface, the front end of the ramp being elevated and angled downwardly as the tray extends towards the rear end. This downwardly sloping ramp commonly meets a bottom or base plate anywhere from one-third to one-half of the distance to the rear end. The elevated front end is commonly supported by L-shaped legs, which are also used for clipping the paint tray to the top rail of a stepladder or the like. These common paint trays are designed to hold paint while sitting horizontally on the floor or being horizontally attached to a ladder.

### BRIEF SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, a paint tray is provided. The paint tray includes a base portion having a paint well and a roller ramp downwardly angled toward the paint well; and a plurality of sidewalls surrounding the base portion; wherein at least one of the base portion and the plurality of sidewalls is substantially covered with a non-stick coating.

In accordance with another aspect of the present invention, a paint tray is provided, which includes: a base portion having a paint well and a roller ramp downwardly angled toward the paint well; a plurality of sidewalls surrounding the base portion, wherein each of the sidewalls have a bottom edge and each of the bottom edges of the sidewalls lie within a common horizontal plane and can be supported continuously along the bottom edges on a flat planar support surface; and at least one gasket portion coupled to the bottom edge of at least one of the plurality of sidewalls to mitigate slippage of the paint tray on the support surface.

In accordance with yet another aspect of the present invention, a paint roller comprises: a roller frame having a generally U-shaped portion and a handle portion; a gripping member coupled to the handle portion; first and second end plugs coupled to a leg of the U-shaped portion; and a non-stick coating applied to at least one of the gripping member, the roller frame and the first and second end plugs.

In accordance with yet another aspect of the present invention, a painting supplies kit includes: a paint tray; and a paint roller, wherein at least one of the paint tray and the paint roller are substantially coated with a non-stick coating.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 illustrates a perspective view of an example of a paint tray in accordance with an aspect of the present invention;

FIG. 2 illustrates a cross sectional view of the paint tray of FIG. 1 in accordance with an aspect of the present invention;

FIG. 3 illustrates a perspective view of a paint roller in accordance with an aspect of the present invention;

FIG. 4 illustrates a cross sectional view of the paint roller of FIG. 3 in accordance with an aspect of the present invention; and

FIG. 5 illustrates a kit having a paint tray and a paint roller in accordance with an aspect of the present invention.

### DESCRIPTION OF EXAMPLE EMBODIMENTS

The present invention relates to a paint tray and roller. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details.

Referring initially to FIG. 1, an example of a paint tray 10 is illustrated in accordance with an aspect of the present invention. The paint tray 10 can be of a one-piece molded or formed construction manufactured from plastic, metal, or any other suitable material. The paint tray 10 includes a base portion 20 and a plurality of sidewalls 30 to define a pan for holding liquid, such as paint, stain, or the like. As illustrated in FIG. 1, the paint tray 10 is of a generally rectangular shape and includes four sidewalls 30. The paint tray 10 can have a width of about eighteen inches, which is a width of commercial paint rollers but can be sized to accommodate alternative sizes. It is to be appreciated that the paint tray 10 can be of any desired shape and/or size and is contemplated as falling within the scope of the present invention. Each of the sidewalls 30 are of substantially the same height H and can extend continuously about a periphery of the paint tray 10. More specifically, the sidewalls 30 are configured such that a bottom edge of the sidewalls 30 lie within a common horizontal plane and can be supported continuously along the bottom edge on a flat planar surface. This sidewall configuration facilitates increased strength and rigidity of the paint tray 10. For instance, the sidewalls facilitate stabilizing of the paint tray 10 when the user rests the paint tray 10 on a level surface and during use of the paint tray 10. Conventional trays are prone to rocking when a paint roller is contacted with the ramp for transfer of paint.

The paint tray 10 further includes a gasket 35 that is coupled to the bottom edge of the sidewalls 30. The gasket 35 provides further stability of the paint tray 10 and mitigates slippage of the paint tray 10 on a surface during use. As illustrated in FIG. 1, the gasket 35 can be coupled to the sidewalls 30 such that the gasket 35 surrounds a bottom perimeter of the tray 10. However, one or more gaskets can be coupled to the bottom edges of the sidewalls 30 at any suitable area(s) (e.g., at the corners) to facilitate stability of the paint tray 10 with respect to a surface upon which the paint tray 10 is placed.

The base portion 20 of the paint tray 10 includes a paint well 40 and an angularly inclined roller ramp 50. The paint well 40 is located at one end of the paint tray 10 and is designed to act as a reservoir to allow paint to be placed therein for dipping a paint roller, brush, or the like. The paint well 40 is rectangular in shape and is defined by three of the sidewalls 30 as well as a bottom edge of the roller ramp 50. The paint well 40 is dimensioned to hold a predetermined amount of paint.

The roller ramp 50 includes one or more main drainage channels 60, which lead into the paint well 40 for draining excess paint from the roller ramp 50. A plurality of secondary drainage channels 65 can be provided on one or both sides of the main drainage channel(s) 60 to facilitate draining excess paint from the side portions of the roller ramp 50 into the paint well 40. It is to be appreciated that any suitable number and configuration of drainage channels can be utilized with the present invention.

The roller ramp 50 provides a surface for evenly applying paint to a paint roller. The roller ramp 50 slopes downward from a rear sidewall 30 to the paint well 40. The ramp 50 includes a plurality of spikes 70, which can be evenly spaced over the surface of the roller ramp 50. During the normal use of a paint tray 10, the roller ramp 50 becomes covered with wet paint. When the paint roller is dipped into the paint well 40, paint is only applied to one half of the roller. Rolling the paint roller up and down the ramp 50 acts to substantially even out the paint on the roller. Due to the inherent nature of paint, the roller ramp 50 becomes slippery, preventing the paint roller from rotating on the ramp 50. Also, the paint on one side of the roller creates an uneven weight balance, discouraging full rotation of the roller on the ramp. The spikes 70 of the present invention aid in the rotation of the roller as it moves up the ramp 50. The spikes 70 are vertically extending protrusions that can be rounded or pointed and are designed to engage a nap of the roller, allowing the roller to freely move up and down the ramp 50. By using spikes 70 to engage the nap of the roller, even paint coverage on the roller is possible. It is not necessary the that the spikes 70 be rounded or pointed but any configuration of projection that will engage the nap of the roller and cause it to rotate, rather than slide, as it moves up and down the ramp 50 will be sufficient for purposes of the present invention.

Optionally, the paint tray 10 can also include two or more handles 80 to facilitate carrying of the paint tray 10. The handles 80, only one of which is shown in FIG. 1, can be of any shape and can be provided as a cutout in opposing sidewalls 30 of the paint tray 10. However, it is to be appreciated that any suitable handle can be integrally formed within the paint tray or alternatively, attached to the paint tray via a suitable fastener.

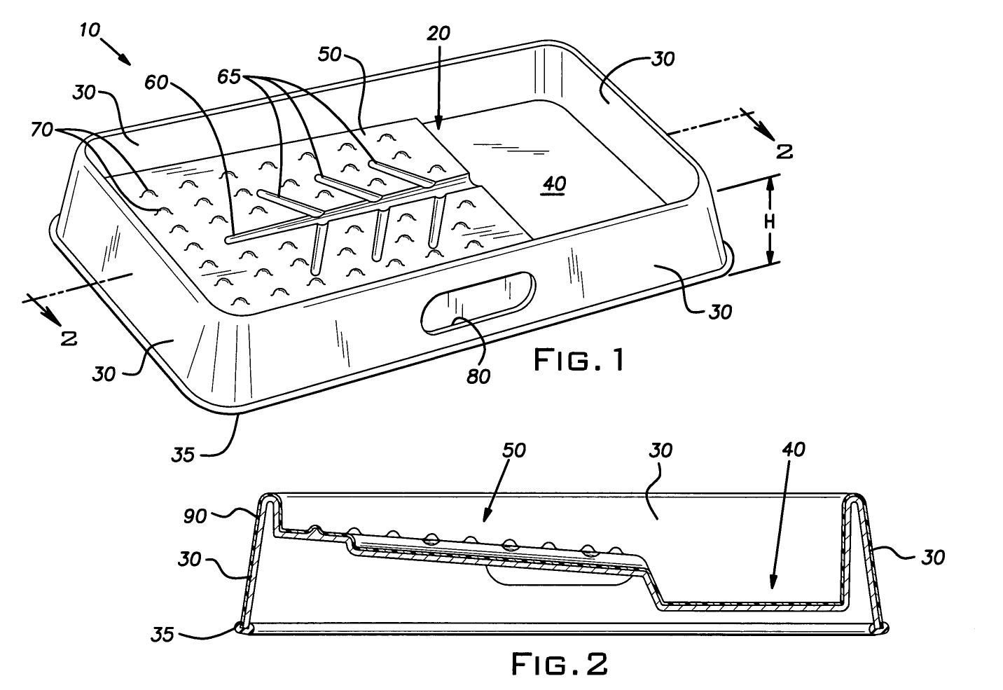

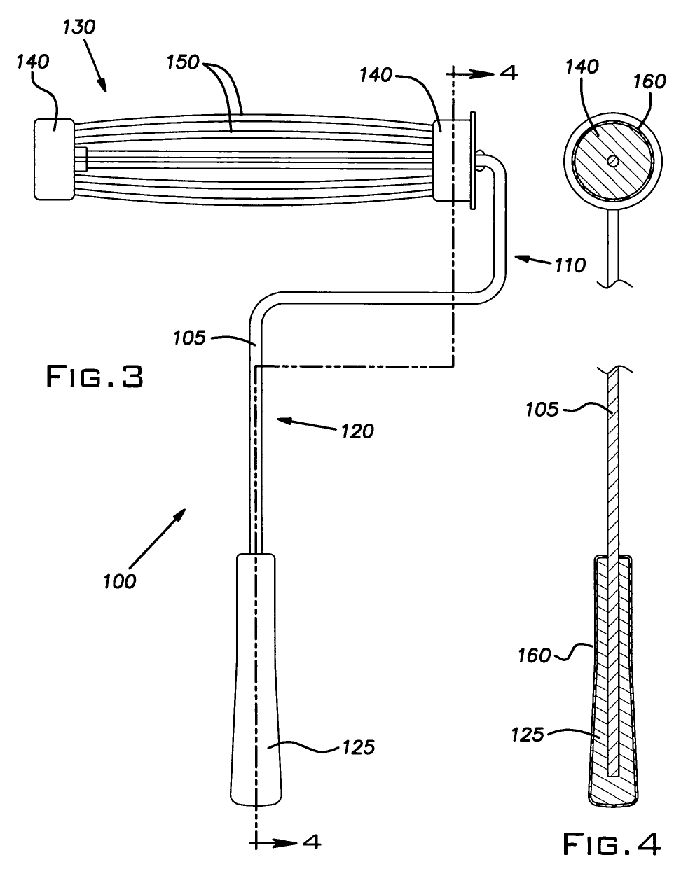

Turning now to FIG. 2, a cross sectional view of the paint tray 10 of FIG. 1 taken along line A-A is illustrated in accordance with an aspect of the present invention. The paint tray 10 includes a non-stick coating 90 on an outer surface thereof. The non-stick coating 90 mitigates paint from ‘sticking’ to the surface of the paint tray. Thus, easier and quicker cleaning of the paint tray 10 can be realized. Moreover, because the paint tray 10 can be easily cleaned, the usable life of the paint tray can be extended. The non-stick coating 90 can be a PTFE or polytetrafluoroethylene coating. However, other suitable materials can be used as the non-stick coating 90. If desired, the non-stick coating can also be applied on a bottom surface of the paint tray 10 such that the entire paint tray 10 is coated substantially evenly with the non-stick coating 90.

Also, as illustrated in the cross sectional view of FIG. 2, the sidewalls 30 can be configured to elevate the paint well 40 and roller ramp 50 portions off of the ground, or support surface. By raising these portions off the support surface, the weight of the paint tray 10 is evenly distributed over the bottom edges of the sidewalls 30. Since the bottom edges have a smaller surface area than the bottom of the paint well 40, the force per unit of surface area exerted onto the ground is increased. This increase in force aids in preventing the paint tray 10 from moving when the roller is rolled up and down the roller ramp 50. As discussed above, the paint tray 10 is further stabilized by use of the gasket 35, which is provided between the bottom edges of the sidewalls 30 and the support surface.

It is to be appreciated that the paint tray 10 can alternatively be configured such that the paint well 40 also contacts the support surface along with the bottom edges of the sidewalls 30.

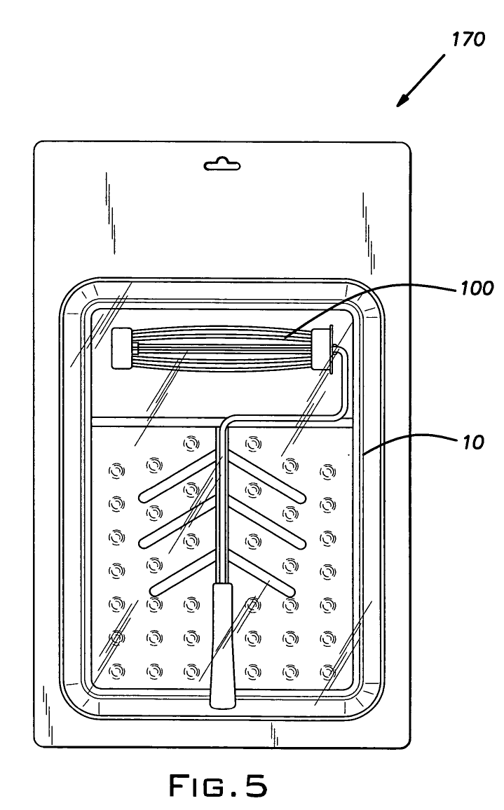

Referring now to FIGS. 3 and 4, a paint roller 100 is illustrated in accordance with an aspect of the present invention. The paint roller 100 includes a roller frame 105 having a generally U-shaped portion 110 and a handle portion 120. The handle portion 120 includes a gripping member 125 to facilitate gripping of the paint roller 100 during use. A roller cage 130 is coupled to one leg of the U-shaped portion 110 such that the roller cage 130 is substantially perpendicular with the handle portion 120. The roller cage 130 is independently rotatable with respect to the roller frame by means well known in the art. The roller cage 130 includes end plugs 140 interconnected by wire spindles 150. The wire spindles 150 bulge slightly outward between the end plugs 140. When a roller (not shown) is attached to the roller cage 130, the wire spindles 150 are somewhat compressed and aid in holding the roller in place. The roller can be of a type well known in the art and has an outer surface capable of retaining and subsequently delivering paint to a surface.

FIG. 4 illustrates a cross-sectional view of the paint roller 100 taken along lines B-B in accordance with an aspect of the present invention. As shown, at least one of the gripping member 125 and the end plugs 140 can be substantially evenly coated with a non-stick coating 160. Similar to the coating of the paint tray 10, the non-stick coating 160 of the paint roller 100 can be a PTFE or polytetrafluoroethylene coating. The non-stick coating 160 facilitates easier and quicker cleaning of the paint roller components. Moreover, because the paint roller components can be easily cleaned, the usable life of the paint roller can be extended. It is to be appreciated that the non-stick coating 160 can be applied to any and all surface areas of the paint roller 100, such as the handle portion 120 and/or the wire spindles 150, for example.

FIG. 5 depicts a painting supplies kit 170 in accordance with an aspect of the present invention. The kit 170 can include the paint tray 10 and the paint roller 100, as described herein. Various other painting supplies (not shown) can also be included in the kit 170 and is contemplated as falling within the scope of the present invention. Moreover, the various other painting supplies can also include a non-stick coating over a portion thereof to facilitate cleaning and to lengthen the usable life of the supplies.

Although the present invention has been described herein with respect to painting supplies, it is to be appreciated that the scope of the present invention is intended to include any suitable tray for holding any suitable liquid therein.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A paint tray comprising:
a base portion having a paint well and a roller ramp downwardly angled toward the paint well; and
a plurality of sidewalls surrounding the base portion;
wherein at least one of the base portion and the plurality of sidewalls is substantially covered with a non-stick coating.

2. The paint tray of claim 1, wherein the non-stick coating is a polytetrafluoroethylene coating.

3. The paint tray of claim 1, wherein the sidewalls are configured such that a bottom edge of the sidewalls lie within a common horizontal plane and can be supported continuously along the bottom edge on a flat planar surface.

3. The paint tray of claim 1, further comprising a gasket coupled to a bottom edge portion of the plurality of sidewalls.

4. The paint tray of claim 1, wherein at least two of the plurality of sidewalls include a cutout handle portion.

5. The paint tray of claim 1, wherein the roller ramp includes a plurality of projections extending from a surface of the roller ramp and at least one drainage channel to facilitate drainage of liquid from the roller ramp into the paint well.

6. A paint tray comprising:
a base portion having a paint well and a roller ramp downwardly angled toward the paint well;
a plurality of sidewalls surrounding the base portion, wherein each of the sidewalls have a bottom edge and each of the bottom edges of the sidewalls lie within a common horizontal plane and can be supported continuously along the bottom edges on a flat planar support surface; and
at least one gasket portion coupled to the bottom edge of at least one of the plurality of sidewalls to mitigate slippage of the paint tray on the support surface.

7. The paint tray of claim 6, further comprising a non-stick coating provided over a surface of the base portion and the plurality of sidewalls.

8. The paint tray of claim 6, wherein at least two of the plurality of sidewalls include a handle portion.

9. The paint tray of claim 6, wherein the roller ramp includes a plurality of projections extending from a surface of the roller ramp and at least one drainage channel to facilitate drainage of liquid from the roller ramp into the paint well.

10. A paint roller comprising:
a roller frame having a generally U-shaped portion and a handle portion;
a gripping member coupled to the handle portion;
first and second end plugs coupled to a leg of the U-shaped portion; and
a non-stick coating applied to at least one of the handle portion, gripping member, roller frame and first and second end plugs.

11. The paint roller of claim 10, wherein the non-stick coating is a polytetrafluoroethylene coating.

12. A painting supplies kit comprising:
a paint tray; and
a paint roller,
wherein at least one of the paint tray and the paint roller are substantially coated with a non-stick coating.

13. The painting supplies kit of claim 12, wherein the non-stick coating is a polytetrafluoroethylene coating.

14. The painting supplies kit of claim 12, wherein the paint tray includes a gasket provided continuously around a bottom portion thereof such that the gasket mitigates slippage of the paint tray on a support surface.

15. The painting supplies kit of claim 12, wherein both of the paint tray and the paint roller are substantially coated with a polytetrafluoroethylene coating.
